(19) United States
(12) Patent Application Publication
(10) Pub. No.: US 2026/0177161 A1
(43) Pub. Date: Jun. 25, 2026

(54) MAGNETIC POSITION DETERMINATION OF A COOLANT VALVE NEEDLE

(71) Applicant: Volkswagen Aktiengesellschaft, Wolfsburg (DE)

(72) Inventors: Ralf DERDA, Wolfsburg (DE); Tom KRUSE, Wolfsburg (DE)

(73) Assignee: Volkswagen Aktiengesellschaft, Wolfsburg (DE)

(21) Appl. No.: 19/540,320

(22) Filed: Feb. 13, 2026

Related U.S. Application Data
(63) Continuation of application No. PCT/EP2024/071937, filed on Aug. 1, 2024.

(30) Foreign Application Priority Data
Aug. 16, 2023 (DE) 10 2023 207 867.8

(51) Int. Cl. F16K 31/04; F02M 51/06; F02M 61/08

(52) U.S. Cl. CPC F16K 31/04; F02M 51/0671; F02M 61/08

(57) ABSTRACT

A needle valve with magnetic position determination of the valve needle, comprising a valve needle seat, a containment shell, a control board, an electric drive with a stator and a rotor, with the rotor being situated in the containment shell, a hollow shaft with an internal thread that is formed by the rotor or is connected to the rotor in a rotationally fixed manner, at least one bearing for the rotor, a valve needle having a valve needle tip, and a valve needle stem with an external thread. A magnetic field sensor is situated above the hollow shaft in the axial direction, outside the containment shell. The external thread of the valve needle stem engages with the internal thread of the hollow shaft, and a mechanism converts the rotational movement of the hollow shaft into a linear movement of the valve needle in the axial direction.

This nonprovisional application is a continuation of International Application No. PCT/EP2024/071937, which was filed on August 1, 2024, and which claims priority to German Patent Application No. 10 2023 207 867.8, which was filed in Germany on August 16, 2023, and which are both herein incorporated by reference.

### BACKGROUND OF THE INVENTION

### Field of the Invention

The invention relates to a needle valve with magnetic position determination of the valve needle, comprising a valve needle seat, a containment shell, a control board, an electric drive with a stator and a rotor, with the rotor being situated in the containment shell, a hollow shaft that has an internal thread and that is formed by the rotor or is connected to the rotor in a rotationally fixed manner, at least one bearing for the rotor, a valve needle having a valve needle tip, and a valve needle stem with an external thread, a magnetic field sensor that is situated above the hollow shaft in an axial direction, outside the containment shell, wherein the external thread of the valve needle stem engages with the internal thread of the hollow shaft, and a mechanism converts the rotational movement of the hollow shaft into a linear movement of the valve needle in the axial direction, and at least the rotor, the hollow shaft, and the valve being arranged axially symmetrically with a shared central longitudinal axis, characterized in that the needle valve further comprises a ring magnet situated above the rotor in an extension of the hollow shaft, and a ferromagnetic metal body that is connected to a free end of the valve stem.

### Description of the Background Art

When a needle valve is used, it is important that the absolute position of the valve needle, in particular the valve closed position in which the valve needle completely closes a flow-through opening, can be identified very accurately and reliably. For example, residual dirt which prevents the needle valve from completely closing may be detected. If the needle valve does not reliably close, it is possible, even with the needle valve closed, for fluid to flow through the needle valve to a downstream unit and thus damage or destroy the downstream unit. Precise, reliable prevention of the coolant flow is imperative, depending on the situation, in particular when the needle valve is a coolant needle valve.

Various approaches are known for solving this problem. A motor-operated valve is known from EP 0383353 A2, which corresponds to US 4,948,091, in which a stator is provided outside a nonmagnetic tubular member, and a rotor is supported, rotatably with respect to the stator, inside the tubular member. The valve includes a mechanism with a rotation preventor for converting the rotational movement of the rotor into a linear movement that moves a valve element toward or away from a valve needle seat. The stator includes multiple magnetic poles with stator coils wound around same, and multiple permanent magnets, having an arch-shaped surface, fastened to the stator coils, wherein the permanent magnets are magnetized to provide a number of pole pairs arranged at uniform intervals. The rotor includes a hub, a rim, and an outer annular portion, and a number of induction teeth that are formed along the circumference of the outer annular portion. The total number of induction teeth is selected to be different from the total number of pole pairs of the permanent magnets by an amount equal to an even number.

US 2008/0092960 A1 relates to a valve system with a position sensor. The position sensor is a magnetic field sensor such as a Hall sensor, via which the axial position of a valve body relative to the valve housing can be determined. The sensor is situated in the valve housing radially next to the valve body, which is movable in the axial direction.

A valve that is electromechanically driven by a stepping motor is known from US 2014/0231684 A1. The valve includes a Hall sensor which is radially mounted on an outer side of the valve and which can indirectly determine whether the valve is closed or open.

US 2021/0175777 A1 relates to a compact control valve with an electromechanical drive. A sensor situated above the rotor can determine the axial position of an axially movable valve based on magnetic field lines. A ring magnet with axial magnetization is situated above the rotor. The distance of the ring magnet from the sensor can be adjusted to detect two or three components of the magnetic field.

A linear actuator for a valve is known from DE 102017110343 A1, having a drive that includes a stator and a rotor. The stator has multiple stator poles around which coil windings are wound. Situated between the individual windings are multiple Hall sensors which may be used to detect the exact position of the rotor.

DE 102020104781 A1 relates to a valve-drive arrangement and a valve apparatus for controlling a fluid flow. The valve apparatus includes an electromechanical drive with a stator and a rotor. In addition, the valve apparatus includes a control unit with control electronics which may comprise a controller, a driver, transformers, transistors, and further passive and active sensors such as Hall sensors.

### SUMMARY OF THE INVENTION

It is therefore an object of the present invention is to provide magnetic position determination for a valve needle of a needle valve, in particular a coolant needle valve, that is made up of few parts and can be inexpensively manufactured.

The invention relates to a needle valve with magnetic position determination of the valve needle, comprising a valve needle seat, a containment shell, a control board, an electric drive with a stator and a rotor, the rotor being situated in the containment shell, a hollow shaft with an internal thread that is formed by the rotor or is connected to the rotor in a rotationally fixed manner, at least one bearing for the rotor, a valve needle having a valve needle tip, and a valve needle stem with an external thread, a magnetic field sensor that is situated above the hollow shaft in an axial direction, outside the containment shell, wherein the external thread of the valve needle stem engages with the internal thread of the hollow shaft, and a mechanism converts the rotational movement of the hollow shaft into a linear movement of the valve needle in the axial direction, at least the rotor, the hollow shaft, and the valve being arranged axially symmetrically with a shared central longitudinal axis, the needle valve further comprising a ring magnet situated above the rotor in an extension of the hollow shaft, and a ferromagnetic metal body that is connected to a free end of the valve stem.

The needle valve may also include a flux guide sleeve that is situated above the ring magnet in the axial direction and conducts the magnetic field or field lines of the magnetic field of the ring magnet in the direction of the Hall sensor. The flux guide sleeve may extend from an end-face side of the ring magnet axially facing the Hall sensor to the inner side of the containment shell. The flux guide sleeve bundles the field lines of the ring magnet and conducts them to the magnetic field sensor. The magnetic field lines extend through the magnetic field sensor, through the air to the stator, and across the ferromagnetic metal body and back to the magnet.

The ring magnet may be made of neodymium-iron-boron or may contain this material, for example Nd₂Fe₁₄B. The magnetic field sensor may be situated coaxially or eccentrically with respect to the shared central longitudinal axis.

The valve housing may have a one-part design and preferably has a multi-part design, and may include at least one inner valve drive housing part or a containment shell that encloses at least the rotor and further parts of the drive, and an outer valve drive housing part that encloses at least the stator, the inner valve drive housing part, and the control board with the sensor for detection of magnetic field lines. A further valve housing part, which is connected to the inner valve drive housing part, may accommodate at least the valve needle or a portion of the valve needle, and the mechanism. The further valve housing part may also be referred to as a valve needle seat.

The inner valve drive housing part may be made of a nonferromagnetic metal, for example a stainless steel, and sealed off from the surroundings. The inner valve drive housing part may be designed as a dome or containment shell. The inner valve drive housing part may have a one-part design, or may be made up of two or more joined-together parts. The outer valve drive housing part may be made of any desired material, and has the task of protecting the control board, the magnetic field sensor, and the stator from soiling and damage. The magnetic field sensor may in particular be a Hall sensor.

The valve needle seat can accommodate the valve needle in such a way that the valve needle can move linearly in the valve needle seat in an axial direction, but cannot rotate in the valve needle seat about a longitudinal axis. In the axial direction the valve needle seat may form a linear guide for the valve needle. The valve needle seat may also include a passage for a fluid, wherein in a first end position of the valve needle the passage is completely closed, and in a second end position of the valve needle the passage is completely open. The valve needle may be steplessly adjusted by the drive. Instead of a stepless adjustment, the valve needle may be adjusted in very finely stepped increments, for example with a gradation of 1000 or more steps. The material for the valve needle seat may be selected by those skilled in the art as a function of the fluid flowing through, for example its temperature, chemical composition, ductility, etc. The valve needle seat is connected to the inner valve drive housing part, and in the connection is sealed off from the surroundings.

The valve needle seat can also include a through opening for the fluid; due to the linear displacement of the valve needle, the through opening may be completely closed, and steplessly or incrementally opened to a maximum.

In addition, a seal that at least reduces leakage of the fluid flowing through the needle valve into the inner valve drive housing part may be situated in the valve needle seat.

The ferromagnetic metal body may be, for example, a cannula made of a ferromagnetic stainless steel with a pressed-in steel plug. In the following discussion, for better identification and differentiation the ferromagnetic metal body is also referred to as a plunger. The cannula may engage with the hollow axis and/or may overlap the free end of the valve needle stem. The plunger may be linearly moved together with the valve needle. The steel plug may have a minimum axial length that essentially corresponds to the maximum travel path of the valve needle from the first end position (valve closed position) into the second end position (valve open position) plus the axial extension of the ring magnet. Based on a characteristic curve, the position of the valve needle can thus always be detected with a single measurement. If the plug has a different, shorter length, the measurement may result in a so-called bathtub curve with two positions that cannot be unambiguously assigned. The minimum length of the plug may be, for example, 6 mm, 7 mm, 8 mm, or any other given path length. In one embodiment, the path length may be > 5.5 mm and < 9 mm, preferably > 6 mm and < 8.5 mm. In one embodiment, the plunger may be a solid rod made of a ferromagnetic material.

In an example, a cylindrical magnet may be situated on the free end of the plunger that faces away from the valve needle and that is axially magnetized oppositely with respect to the ring magnet. The cylindrical magnet assists with short-circuiting the ring magnet, since it accelerates the magnetic flux through the upper end of the plunger.

When the plunger is situated inside the ring magnet or retracts into the opening in the ring magnet, in a manner of speaking it short-circuits the ring magnet in the interior. As a result, the majority of the field lines of the magnetic field of the ring magnet no longer run to the sensor. This results in only a low flux density for the magnetic field sensor.

The valve needle stem and the ferromagnetic metal body may have identical diameters, for example the diameter of the valve needle stem in the area next to the external thread. If an inner diameter of the hollow shaft, an inner diameter of the opening in the ring magnet, and an inner diameter of the flux guide sleeve then corresponds essentially to the stated diameter, the valve needle with the connected ferromagnetic metal body may be inserted into the hollow shaft from the side of the rotor facing away from the Hall sensor and screwed in. This allows simple manufacture of the inner valve drive housing part or the containment shell, since it has to be open on only one side.

The rotor may be rotatably supported in at least one bearing, wherein the bearing may be situated in the valve needle seat or the containment shell. The at least one bearing may be a rotary bearing for the rotor. A further rotary bearing may be formed in the containment shell above the end-face side of the rotor facing the Hall sensor. In one embodiment, a slide bearing for the ferromagnetic metal body may be present at the end of the valve needle stem in the containment shell, below the Hall sensor. The slide bearing may form a receptacle for the ring magnet and/or the flux guide sleeve.

The Hall sensor may in particular be a lateral Hall sensor or a linear Hall sensor, which provides the option for masking or truncating measured value ranges in order to "pick out" a profile region that is as linear as possible. The Hall sensor is situated outside the inner valve drive housing part in an area above the hollow shaft. At least the hollow shaft, the rotor, and the valve needle have a shared central longitudinal axis. The Hall sensor is situated at the circuit board or at a side of the circuit board facing the containment shell in such a way that this shared central longitudinal axis intersects, does not intersect, or at least does not centrally intersect the Hall sensor.

In an example, a ferromagnetic half-shell with a borehole may be centrally placed on the outer surface of the inner valve drive housing in order to form magnetic feedback and thus provide better protection for the sensor system from interferences. Such a half-shell is complicated to manufacture and incurs additional costs.

Lastly, in an example with a multi-part containment shell, the upper end of the ferromagnetic metal part may be dimensioned differently and the structure may be configured differently above the rotor, since installation through the hollow shaft is no longer necessary.

The needle valve allows highly accurate magnetic position determination of the valve needle, in particular when there is a large distance between the ring magnet and the sensor. The flux conduction of the magnetic field to the Hall sensor takes place from a ferromagnetic material via a flux guide sleeve. At the point of interest for the closing operation of the needle valve, a strong change in flux is generated by short-circuiting the ring magnet. The sensor accuracy is increased with low material outlay. That is, the approach provides a needle valve having low material unit costs (ring magnet, flux guide sleeve, steel cannula, steel plug, simplest Hall sensor), and savings in weight and installation space, since the approach involves no additional installation space due to the ease of integrating the ring magnet and the flux guide sleeve into the upper slide bearing of the rotor.

Besides the described needle valve, the subject matter of the invention may be advantageously utilized for all applications with linear movements in which the linearly moved parts are difficult to reach and/or are encapsulated. Valves for drive motors such as the internal combustion engine, in the exhaust system or in the brake booster, are examples of such applications. The invention allows an end stop to be sensed before it is actually reached, for example for a steering system, a damper, or the brake booster. In addition, the invention may be utilized for all areas of application of a system with expanding coolants (air conditioner systems), gas valves for turbines or boilers, and for recognizing whether a locking bolt at a poorly accessible installation site (for example, a rotor locking system in offshore wind turbines) is actually open.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a needle valve with a Hall sensor in a vertical sectional view along the rotational axis of the rotor;

FIG. 2 shows a detailed view of the upper portion of the containment shell of the needle valve in FIG. 1 in the valve closed position;

FIG. 3 shows a detailed view of the upper portion of the containment shell of the needle valve in FIG. 1 in an intermediate position;

FIG. 4 shows an example of a flux density characteristic curve during movement of the valve needle of the needle valve in FIG. 1;

FIG. 5 shows a detailed view of the upper portion of the containment shell of a needle valve with an additional cylindrical magnet on the steel plug; and

FIG. 6 shows an example of a flux density characteristic curve during movement of the needle valve in FIG. 5.

### DETAILED DESCRIPTION

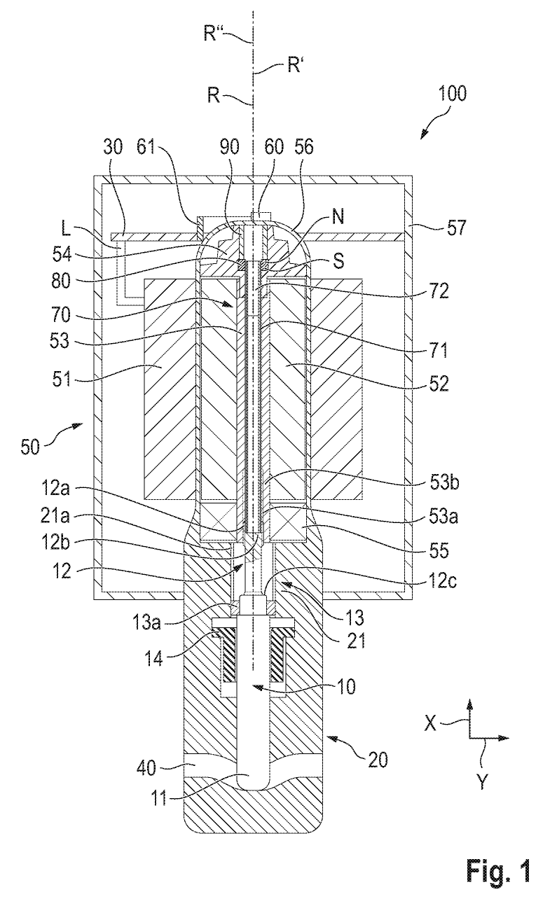

FIG. 1 shows an example of a needle valve 100. The needle valve 100 includes a drive 50 or electromechanical drive with a rotor 52 and a stator 51. The stator 51 may have, for example, a core made of sheet iron and windings made of copper or copper wire. The rotor 52 may be a permanent magnet or may be formed, at least in part, from permanent magnet material. The needle valve 100 also includes a ring magnet 80.

The rotor 52 may form a hollow shaft 53 or may be connected to a hollow shaft 53 in a rotationally fixed manner. The rotor 52 radially encloses the hollow shaft 53. A rotational axis or central longitudinal axis R of the rotor 52 is identical to a rotational axis or central longitudinal axis R' of the hollow shaft 53. The hollow shaft 53 is open at both axial ends. An internal thread is formed inside the hollow shaft 53 in an axial section of the inner circumferential wall 53b, between the two axial ends. The internal thread 53a may be formed, for example, at an axial end of the hollow shaft 53.

The needle valve 100 also includes a valve needle 10 having a valve needle stem 12, a valve needle guide section 13, and a valve needle tip 11. The valve needle stem 12 has a free end 12b, and an axially opposite end 12c that connects the valve needle stem 12 to the valve needle guide section 13. At the valve needle stem 12, an external thread 12a is formed in a section between the free end 12b and the end 12c next to the needle guide section 13.

The valve needle guide section 13 is an engagement element 13a that is formed between the valve needle stem 12 and the valve needle tip 11. The engagement element 13a cooperates with a counterengagement element 21 of the valve needle seat 20. When the valve needle guide section 13, i.e., the engagement element 13a, is engaged with the counterengagement element 21, the valve needle 10 is nonrotatably supported in the valve needle seat 20 and can be moved in a linear guide 21a in the axial direction X.

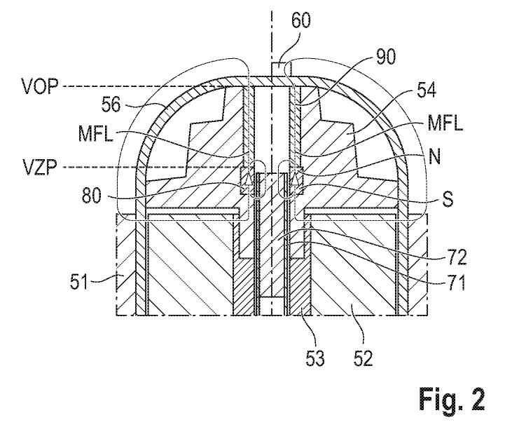

A ferromagnetic metal body or plunger 70, for example a steel cannula 71 with a pressed-in steel plug 72, is connected to the free end 12b of the valve needle stem 12. The steel plug 72 may have an axial length that essentially corresponds to a maximum travel path of the valve needle 10 from the valve closed position VZP into the valve open position VOP (FIG. 2) plus the axial length of the ring magnet 80.

A bearing or slide bearing 54 which linearly guides the plunger 70 and/or rotationally supports the rotor 52 and/or which may axially support the rotor 52 and the hollow shaft 53 is situated above the rotor 52. The slide bearing 54 may be cast from plastic, for example.

In the example, the slide bearing 54 includes a receptacle for the axially magnetized ring magnet 80 with a south pole S and a north pole N, wherein the ring magnet 80 is situated in the slide bearing 54 near the hollow shaft 53, and forms a receptacle for a flux guide sleeve 90 that extends from an axial end-face side of the ring magnet 80 to an axial end of the bearing 54 facing away from the rotor 52.

A further bearing or roller bearing 55, in the exemplary embodiment a pivot bearing for the rotor 52, is situated below the rotor 52. Instead of the slide bearing 54, the roller bearing 55 may form the axial support for the rotor 52 and the hollow shaft 53.

The rotor 52, the slide bearing 54, the ring magnet 80, and the flux guide sleeve 90 are enclosed by a containment shell 56 or an inner valve drive housing part. The containment shell 56 is made of a nonferromagnetic metal such as stainless steel (X5CRNI18-10 V2A, for example), and has a closed, bell-like dome shape that is open at the bottom. The containment shell 56 at its open end is connected to the valve needle seat 20, with the connection area being sealed off so that neither the interior of the containment shell 56 nor the interior of the valve needle seat 20 is connected to the surroundings.

The valve needle 10 with the valve needle stem 12 may be inserted into the hollow shaft 53 and screwed in, with the external thread 12a of the valve needle stem 12 being screwed into the internal thread 53a of the hollow shaft 53. The threaded connection of the hollow shaft 53 with the valve needle stem 12, and the valve needle guide section 13 with the engagement element 13a and the counterengagement element 21, together form a mechanism that converts a rotational movement of the hollow shaft 53 into an axial linear movement of the valve needle 10. The valve needle 10 has a central longitudinal axis R'' that coincides with the rotational axis R' of the hollow shaft 53 and with the rotational axis R of the rotor 52 when the valve needle stem 12 is screwed into the hollow shaft 53.

The needle valve 100 also includes a control board 30 that is connected to the stator 51 via a line L, so that a controller that is encompassed by the control board 30 or connected to the control board 30 electrically controls the stator 51, so that the stator magnetically sets the rotor 52 in rotation with an adjustable rotational speed and an adjustable rotational direction.

A magnetic field sensor 60 for detecting the local flux density, based on the magnetic field of the ring magnet 80, is connected to the control board 30. The magnetic field sensor 60 may be a lateral Hall sensor or a linear Hall sensor. In the exemplary embodiment, the magnetic field sensor 60 is connected to a sensor holder 61 and situated above the control board 30. The magnetic field sensor 60 is situated above the hollow shaft 53 on the outside of the containment shell 56.

The stator 51, the control board 30, the magnetic field sensor 60, and the containment shell 56 are situated in a drive housing 57. The drive housing 57 may be made of a suitable material, for example plastic, and protects the stated components from soiling and damage.

The valve needle seat 20 also includes a flow-through opening 40 for a fluid such as a coolant. The valve needle 10 or valve needle tip 11 can completely close the flow-through opening 40 in the valve closed position VZP, and can maximally open it in the valve open position VOP. A valve needle seal 14, which in the exemplary embodiment is situated in the valve needle seat 20 below the mechanism, at least prevents leakage of the fluid through the valve needle seat 20 and into the containment shell 56.

FIG. 2 shows a detailed view of the upper section of the needle valve 100 in FIG. 1.

The needle valve 100 with the valve needle 10 is shown in the valve closed position VZP. The slide bearing 54 above the rotor 52 supports the ring magnet 80 as well as the flux guide sleeve 90. The axial free end of the steel plug 72 is situated at or slightly below the level of the axial end of the north pole N of the ring magnet 60, which in the exemplary embodiment faces the flux guide sleeve 90. The steel plug 72 is connected to the valve needle stem 12 via a steel cannula 71, and together with the valve needle 10 can be linearly moved in the axial direction X.

The needle valve 100 may additionally include a half-shell made of a ferromagnetic material, which rests tightly against a surface of the outer side of the containment shell 56, above the stator 51. The optional half-shell at the sides is pulled to below the stator lamination, and at the top has an opening that is large enough so that the magnetic flux is not directed past the magnetic field sensor 60, and instead is guided through the magnetic field sensor 60. The half-shell may, for example, have a wall thickness similar to that of the flux guide sleeve 90.

As a result of the steel plug 72 extending into the ring magnet 80, the axially poled ring magnet 80 is short-circuited in its interior, so that there is little or no conduction of the magnetic field lines MFL to the magnetic field sensor 60. The flux density drops as soon as the steel plug 72 retracts into the ring magnet. The change in the flux density is greatest when the steel plug 72 reaches the upper edge of the ring magnet 80. This maximum change in the flux density may be directly associated with the valve closed position VZP.

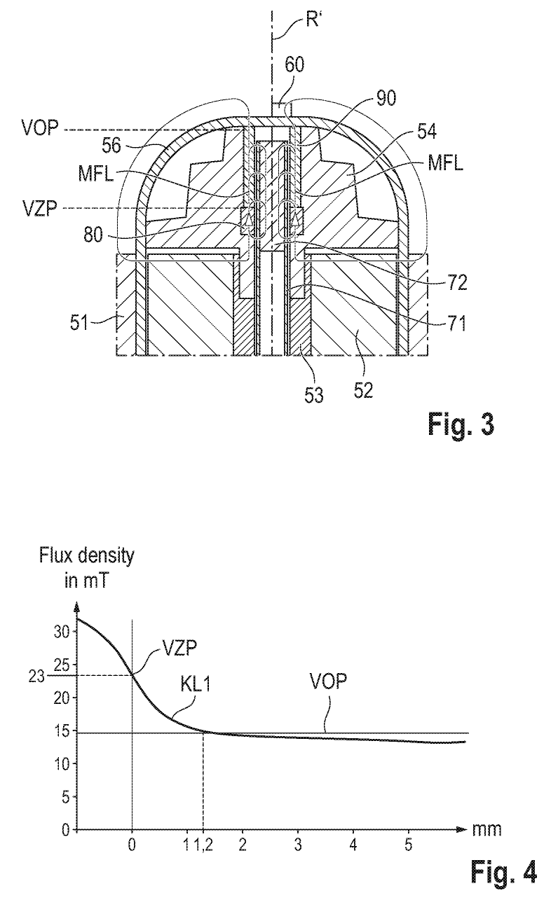

FIG. 3 shows essentially the same view as FIG. 2, except that the valve needle has been moved out of the valve closed position VZP and is now between the valve closed position VZP and the valve open position VOP.

The steel plug 72 still short-circuits the ring magnet 80, but together with the flux guide sleeve 90 also forms an air gap area that becomes larger the farther the steel plug 72 moves into the flux guide sleeve 90. As a result, the magnetic field of the ring magnet 80 is short-circuited even more intensely, so that fewer magnetic field lines MFL are now conducted to the magnetic field sensor 60, which thus measures a lower flux density. The lower flux density is a sign that the valve needle 10 has left the valve closed position VZP. The flux density changes most distinctly at the start of the opening movement, and may be essentially constant when a certain degree of opening is reached.

Conversely, this means that when the valve closes, the flux density once again increases, and a maximum is reached when the steel plug 72 is completely extended from the flux guide sleeve. The unintentional complete extension of the steel plug 72 may be prevented by means of a mechanical end stop. That is, the flux density in the region of the valve closed position VZP reaches a value that is below the maximum.

FIG. 4 shows an example of a characteristic curve KL1 for the linear movement of the valve needle 10 of a needle valve 100, with a magnetic flux density of 23 mT in the valve closed position VZP and a magnetic flux density of 15 mT when the valve needle 10 has been moved 1.2 mm from the valve closed position VZP in the direction of the valve open position VOP. When the valve needle 10 is moved farther in the direction of the valve open position VOP, there is essentially no further change in the magnetic flux density.

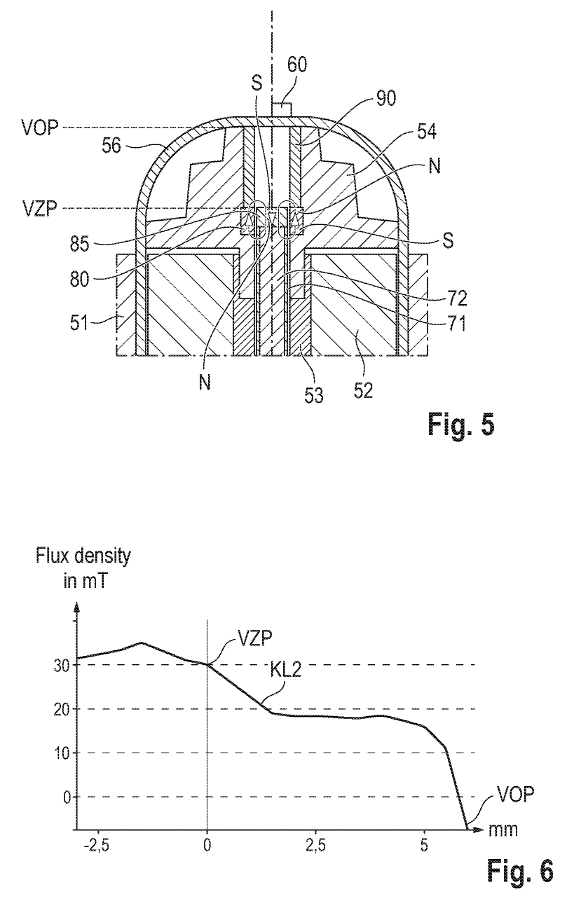

FIG. 5 shows a further example in which the needle valve 100 includes an additional magnet 85 that is likewise axially poled. The additional magnet 85 is situated at the free end of the steel plug 72, with the axial poles N, S of this additional magnet 85 being opposite from the poles N, S of the ring magnet 80. The additional magnet 85 assists with short-circuiting of the ring magnet 80. Furthermore, an additional high magnetic flux density at the magnetic field sensor 60 results when the valve needle is in the valve open position VOP.

FIG. 6 illustrates the characteristic curve KL2 for the needle valve 100 in FIG. 5. The characteristic curve KL2 has an approximately linear function around the valve closed position VZP. In the valve open position VOP the flux density goes steeply into the negative region. There is hardly any change in the flux density in the middle portion.

In FIG. 6, the flux density in the valve closed position VZP is greater than 30 mT, and after the valve needle is moved 1.5 mm in the direction of the valve open position VOP it is approximately 18 mT, and remains essentially the same over the displacement length of the valve needle 10 beyond 3 mm. If the valve needle were moved 5 mm in the direction of the valve open position VOP, the flux density measured by the magnetic field sensor 60 would be just 16 mT, and would continue to drop as the valve needle 10 is moved farther into the valve open position VOP.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A needle valve with magnetic position determination of the valve needle, the valve needle comprising:
a valve needle seat;
a containment shell;
a control board;
an electric drive with a stator and a rotor, the rotor being arranged in the containment shell;
a hollow shaft that has an internal thread and that is formed by the rotor or is connected to the rotor in a rotationally fixed manner;
at least one bearing for the rotor;
a valve needle with a valve needle tip and a valve needle stem with an external thread; and
a magnetic field sensor that is arranged above the hollow shaft in an axial direction outside the containment shell,
wherein the external thread of the valve needle stem engages with the internal thread of the hollow shaft,
wherein a mechanism converts the rotational movement of the hollow shaft into a linear movement of the valve needle in the axial direction,
wherein at least the rotor, the hollow shaft, and the valve needle are arranged axially symmetrically with a shared central longitudinal axis,
wherein the needle valve further comprises a ring magnet arranged above the rotor in an extension of the hollow shaft, and
a ferromagnetic metal body that is connected to a free end of the valve stem.

2. The needle valve according to claim 1, wherein the needle valve also includes a flux guide sleeve that is arranged above the ring magnet in the axial direction.

3. The needle valve according to claim 1, wherein at least the rotor, the hollow shaft, the ferromagnetic metal body, and the ring magnet are arranged in the containment shell.

4. The needle valve according to claim 1, wherein the stator is arranged outside the containment shell and radially encloses the containment shell, and wherein the stator drives the rotor without contact.

5. The needle valve according to claim 1, wherein the magnetic field sensor is situated eccentrically or coaxially with respect to the shared central longitudinal axis.

6. The needle valve according to claim 1, wherein the ring magnet has an axial magnetization with a south pole and a north pole, and wherein, upon a linear movement of the valve needle, the ferromagnetic metal body retracts into the ring magnet and short-circuits the interior of the ring magnet.

7. The needle valve according to claim 1, wherein the ferromagnetic metal body includes a cannula made of ferromagnetic material, and a highly permeable flux guide.

8. The needle valve according to claim 7, wherein a minimum axial length of the highly permeable flux guide corresponds to a maximum travel path of the valve needle from a valve closed position, in which the needle valve is completely closed, into a valve open position, in which the needle valve is maximally open, and the axial extension of the ring magnet.

9. The needle valve according to claim 1, wherein the needle valve comprises a further axially magnetized magnet having magnetization that is opposite the magnetization of the ring magnet, and wherein the further magnet is arranged at a free axial end of the ferromagnetic metal body.

10. The needle valve according to claim 1, wherein the needle valve is a coolant valve.
